(19) United States
(12) Patent Application Publication
(10) Pub. No.: US 2015/0313288 A1
(43) Pub. Date: Nov. 5, 2015

(54) ELECTRONIC CIGARETTE

(71) Applicant: KIMREE HI-TECH INC., RoadTown (VG)

(72) Inventor: Qiuming LIU, Huizhou (CN)

(21) Appl. No.: 14/712,228

(22) Filed: May 14, 2015

Related U.S. Application Data
(63) Continuation of application No. PCT/CN2014/076580, filed on Apr. 30, 2014.

(51) Int. Cl. A24F 47/00; H05B 1/02; H05B 3/40; F22B 1/28

(52) U.S. Cl. CPC A24F 47/008; F22B 1/284; H05B 1/0244; H05B 3/40

(57) ABSTRACT

An electronic cigarette having a liquid container which is detachable by pressing and rotating is provided according to the present application. The electronic cigarette includes a suction end, a liquid container, an atomizer assembly, and a battery rod assembly. An accommodating groove is provided in the atomizer assembly. A space is provided between a movable member and the accommodating groove, thus the liquid container is rotatable freely with respect to the atomizer assembly. A first engaging portion is provided in the accommodating groove. A second engaging portion is provided on the surface of the movable member. When the first engaging portion is engaged with the second engaging portion, the free rotation of the movable member with respect to the atomizer assembly is prevented, thus the liquid container may be rotated with respect to the movable member to be removed from the atomizer assembly.

### CROSS REFERENCE TO RELATED APPLICATIONS

This application is a continuation under 35 U.S.C. §120 of PCT/CN2014/076580, filed Apr. 30, 2014, which is incorporated herein reference.

### TECHNICAL FIELD

The present application relates to the technical field of electronic cigarettes, and particularly to an electronic cigarette having a liquid container which is detachable by pressing and rotating.

### BACKGROUND

With the improvement of health consciousness, more and more people realize the harm of smoking, thus, electronic cigarettes, which are healthier than the real cigarettes, become popular.

The structure of a conventional electronic cigarette is shown in FIG. 14. As shown in FIG. 14, the conventional electronic cigarette includes an atomizer assembly 110 and a battery rod assembly 120 which are connected to each other. An end, away from the battery rod assembly 120, of the atomizer assembly 110 functions as a suction end 100 which allows a user to inhale smoke. Further referring to FIG. 14, the atomizer assembly 110 is provided with a sleeve 111, and a liquid storage cotton 112 for storing the cigarette liquid and an electrical heating wire assembly 113 for atomizing the cigarette liquid are provided in the sleeve 111. A smoke channel is formed inside the electronic cigarette, thus the user may inhale the smoke atomized by the electric heating wire assembly 113 through the smoke channel.

In the electronic cigarette shown in FIG. 14, the liquid storage cotton 112 is close to the suction end 100, and the smoke channel is arranged in the axis of the liquid storage cotton 112, thus the cigarette liquid in the liquid storage cotton 112 is prone to leak into the smoke channel, and in this case, the cigarette liquid which has not been atomized may be inhaled by the user. Meanwhile, for the electronic cigarette with such structure, in the case that a child removes the end cap at the end of the atomizing assembly 110, the child might suck in the cigarette liquid in the sleeve 111, which may cause a hidden danger.

### SUMMARY

In view of this, an electronic cigarette having a liquid container which is detachable by pressing and rotating is provided according to the present application.

The electronic cigarette includes an electronic cigarette body;

the electronic cigarette body is provided with a suction end, a liquid container for containing cigarette liquid, an atomizing assembly for atomizing the cigarette liquid, and a battery rod assembly for providing power to the atomizer assembly; the liquid container is arranged on an end, away from the suction end, of the electronic cigarette body, and is detachably connected to the atomizer assembly;

an accommodating groove is provided in the atomizer assembly, and a movable member is movably provided in the accommodating groove and is configured to be detachably connected to the liquid container, and the liquid container is rotatable freely with respect to the atomizer assembly together with the movable member;

a first engaging portion is provided in the accommodating groove;

a second engaging portion configured to engage with the first engaging portion is provided on a surface of the movable member; and

a free rotation of the movable member with respect to the atomizer assembly is configured to be prevented in the case that the first engaging portion is engaged with the second engaging portion, to allow the liquid container to rotate with respect to the movable member to be disengaged from the atomizer assembly.

In the electronic cigarette of the present application, the atomizing assembly is further provided with a connecting member and an atomizing sleeve,

the atomizing sleeve is configured to wrap and protect the atomizer assembly,

the connecting member and the atomizing sleeve define the accommodating groove, and the atomizing sleeve forms a wall of the accommodating groove, and the connecting member forms an end of the accommodating groove,

the first engaging portion is arranged at a surface, configured to be in contact with the movable member, of the connecting member, and the first engaging portion includes a first engaging tooth, and

the second engaging portion is arranged at the surface, configured to be in contact with the connecting member, of the movable member, and the second engaging portion includes a second engaging tooth.

In the electronic cigarette of the present application, the atomizer assembly and the liquid container are detachably connected by rotational fastening connection,

the second engaging tooth is provided with a first contact surface, and the first contact surface is configured to be in contact with the first engaging tooth in the case that the second engaging tooth is engaged with the first engaging tooth when the liquid container is rotated in a direction to be fastened to the atomizer assembly,

the first contact surface is perpendicular to the surface of the movable member,

the second engaging tooth is further provided with a second contact surface, and the second contact surface is configured to be in contact with the first engaging tooth in the case that the second engaging tooth is engaged with the first engaging tooth when the liquid container is rotated in a direction to be disengaged from the atomizer assembly, and

the second contact surface is an inclined surface.

In the electronic cigarette of the present application, the rotational fastening connection is a threaded connection,

or,

a connecting end, connected to the movable member, of the liquid container is provided with a boss protruding out of a surface of the connecting end;

a guiding groove for leading in the boss is provided inside the movable member;

an end of the guiding groove is provided with a limiting groove which is in communication with the guiding groove and extends in a radial direction of the movable member, and

in the case that the boss is inserted into the guiding groove and reaches the end of the guiding groove, the boss is configured to be rotated into the limiting groove, to be snapped into the limiting groove.

In the electronic cigarette of the present application, the second engaging tooth is a triangular body protruding out of the surface of the movable member,

or,

the second engaging tooth is a triangular body being recessed into the surface of the movable member.

In the electronic cigarette of the present application, a space is provided between the connecting member and the movable member, and in the space, an elastic element is provided in the atomizing sleeve in a circumferential direction, and

the elastic element is configured to prevent engagement between the first engaging portion and the second engaging portion in the case that the liquid container is rotated freely with respect to the atomizer assembly.

In the electronic cigarette of the present application, the first engaging portion includes a press strip provided on the wall of the accommodating groove, and

the second engaging portion includes an elastic fastener provided on the movable member and configured to cooperate with the press strip, and the elastic fastener is configured to retain the press strip to prevent the free rotation of the liquid container with respect to the atomizer assembly, to allow the liquid container to be disengaged from the atomizer assembly.

In the electronic cigarette of the present application, an indicator is provided outside the atomizer assembly, and is configured to indicate the position of the elastic fastener, to allow the elastic fastener to be pressed by an external force to retain the press strip, to prevent the free rotation of the liquid container with respect to the atomizer assembly.

In the electronic cigarette of the present application, the connecting member is provided with a fixing end,

the fixing end is provided with a retaining groove configured to be fixedly connected to the atomizing sleeve, and

the atomizing sleeve is provided with a retaining portion configured to cooperate with the retaining groove to fix the connecting member.

In the electronic cigarette of the present application, a space is provided between the movable member and the accommodating groove, and is configured to allow the movable member to be rotatable freely with respect to the atomizer assembly.

In the electronic cigarette of the present application, the battery rod assembly is arranged in parallel with the liquid container.

In the electronic cigarette of the present application, the connecting member is provided with a first connecting portion configured to threadedly cooperate with the battery rod assembly,

the battery rod assembly is provided with a second connecting portion configured to cooperatively connected to the first connecting portion, and

the first connecting portion is detachably connected to the second connecting portion.

In the electronic cigarette of the present application, the movable member is of a hollow structure,

the atomizer assembly is further provided with an atomizing core for atomizing the cigarette liquid, and the atomizing core has one end inserted in the liquid container and another end extending out of the liquid container, and

the hollow structure of the movable member is configured to allow the atomizing core to pass through.

In the electronic cigarette of the present application, the atomizing core includes a sleeve, an atomizing electrode, an electric heating wire assembly, and a cigarette liquid storing member,

the cigarette liquid storing member is provided in the sleeve and fits closely to an inner circumferential surface of the sleeve, and is configured to deliver the cigarette liquid in the liquid container to the electric heating wire assembly to be atomized, and to prevent leakage of the cigarette liquid in the case that the liquid container is placed upside down,

the sleeve is configured to wrap and protect the cigarette liquid storing member,

the atomizing electrode is provided at one end of the sleeve, and is configured to communicate the electric heating wire assembly with the battery rod assembly, to allow the battery assembly to provide power to the electric heating wire assembly, and

the electric heating wire assembly is provided in the sleeve and is configured to atomize the cigarette liquid to generate smoke.

In the electronic cigarette of the present application, a sealing ring for sealing is provided at a contacting portion of the movable member and the atomizing core.

Based on the above technical solutions, the embodiments of the present application have the following advantages.

The electronic cigarette includes an electronic cigarette body, and the electronic cigarette body is provided with a suction end, a liquid container for containing the cigarette liquid, an atomizer assembly for atomizing the cigarette liquid, and a battery rod assembly for powering the atomizer assembly. The liquid container is arranged at an end of the electronic cigarette body away from the suction end. The liquid container of the electronic cigarette is provided at the end of the electronic cigarette body away from the suction end, that is, the liquid container is arranged away from the suction end, thus, the electronic cigarette according to the present application may effectively prevent a user from inhaling the cigarette liquid which has not been atomized. In the present application, the accommodating groove is provided inside the atomizer assembly, the movable member detachably connected to the liquid container is accommodated in the accommodating groove, and a space is provided between the movable member and the accommodating groove. Thus, the movable member is rotatable freely with respect to the accommodating groove, and the liquid container connected to the movable member is rotatable freely with respect to the atomizer assembly. The first engaging portion is provided inside the accommodating groove, the second engaging portion configured to engage with the first engaging portion is provided on the surface of the movable member, and in the case that the first engaging portion is engaged with the second engaging portion, a free rotation of the movable member with respect to the atomizer assembly is prevented, thus the liquid container may be rotated with respect to the movable member, to be detached from the atomizer assembly. To engage the first engaging portion with the second engaging portion, an external force is required to be applied on the electronic cigarette, for example pushing the liquid container or pressing the atomizer assembly. Without applying an external force, the first engaging portion cannot be engaged with the second engaging portion, thus the liquid container cannot be detached from the atomizer assembly. Therefore, it is difficult for a child to remove the liquid container. When the child rotates the liquid container, the liquid container can only rotate freely on the atomizer assembly but cannot be removed, thereby avoiding the child sucking in the cigarette liquid in the liquid container by mistake. Further, when the electronic cigarette is used or carried by the user, the liquid container will not be disengaged from the atomizer assembly, thereby avoiding the liquid container being damaged and further affecting the usage of the electronic cigarette. In addition, the liquid container of the electronic cigarette is provided at the end of the electronic cigarette body away from the suction end, that is, the liquid container is arranged away from the suction end, thus, the electronic cigarette according to the present application may effectively prevent a user from inhaling the cigarette liquid which has not been atomized. Thirdly, with such structure, the liquid container can be detached for filling the cigarette liquid, which avoids the situation in the liquid filling process of the conventional electronic cigarette that, the cigarette liquid is overly filled by accident, which causes the smoke channel to be submerged by the cigarette liquid, and further causes the atomizer to be unable to atomize the cigarette liquid.

### BRIEF DESCRIPTION OF THE DRAWINGS

For more clearly illustrating embodiments of the present application or the technical solution in the conventional technology, drawings referred to describe the embodiments or the conventional technology will be briefly described hereinafter. Apparently, the drawings in the following description are only several embodiments of the present application, and for the person skilled in the art, other drawings may be obtained based on these drawings without any creative efforts.

FIG. 1 is a schematic view showing the overall structure of an embodiment of an electronic cigarette according to the present application;

FIG. 2 is a schematic view showing the overall structure of another embodiment of the electronic cigarette according to the present application;

FIG. 3 is a schematic view showing the structure of an embodiment of a movable member of the electronic cigarette according to the present application;

FIG. 4 is a schematic view showing the structure of an embodiment of a liquid container of the electronic cigarette according to the present application;

FIG. 5 is a schematic view showing the structure of another embodiment of the movable member of the electronic cigarette according to the present application;

FIG. 6 is a schematic view showing the structure of an embodiment of a connecting member of the electronic cigarette according to the present application;

FIG. 7 is a sectional view of an embodiment of the electronic cigarette according to the present application;

FIG. 8 is a schematic view showing the structure of an embodiment of an atomizing sleeve of the electronic cigarette according to the present application;

FIG. 9 is a schematic view showing the structure of another embodiment of the movable member of the electronic cigarette according to the present application;

FIG. 10 is a sectional view of another embodiment of the electronic cigarette according to the present application;

FIG. 11 is a schematic view showing the structure of an embodiment of a connecting member and a battery rod assembly of the electronic cigarette according to the present application;

FIG. 12 is a sectional view of another embodiment of the electronic cigarette according to the present application;

FIG. 13 is a sectional view of another embodiment of the electronic cigarette according to the present application; and

FIG. 14 is a sectional view of a conventional electronic cigarette.

Reference numerals:

| | | | |
|---|---|---|---|
| 10 | suction end, | 11 | battery rod assembly, |
| 12 | atomizer assembly, | 13 | liquid container, |
| 120 | connecting member, | 121 | movable member, |
| 122 | atomizing sleeve, | 124 | sealing ring, |
| 21 | first engaging tooth, | 22 | first engaging tooth, |
| 31 | press strip, | 32 | elastic fastener, |
| 211 | first contact surface, | 212 | second contact surface, |
| 101 | boss, | 102 | guiding groove, |
| 103 | limiting groove, | 201 | retaining groove, |
| 401 | first connecting portion, | 402 | second connecting portion, |
| 40 | atomizing core, | 43 | electric heating wire |
| | | | assembly, |
| 41 | sleeve, | 42 | atomizing electrode, and |
| 44 | cigarette liquid storing | | |
| | member. | | |

### DETAILED DESCRIPTION

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of the present application.

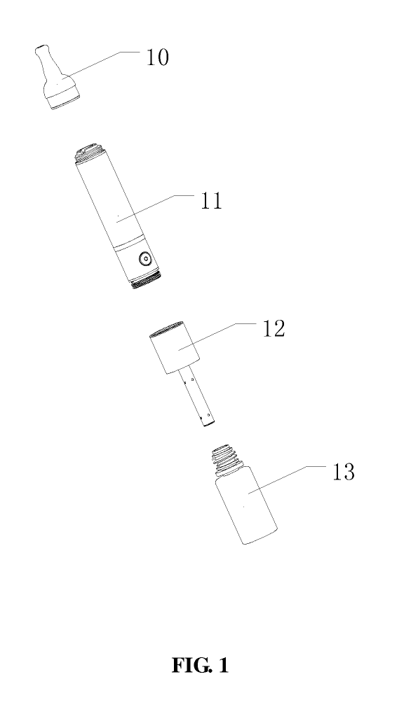

According to the present application, an electronic cigarette using a liquid container which is detachable by pressing and rotating is provided. The electronic cigarette includes an electronic cigarette body. Reference is made to FIG. 1. The electronic cigarette body is provided with a suction end 10, a liquid container 13 for containing cigarette liquid, an atomizer assembly 12 for atomizing the cigarette liquid, and a battery rod assembly 11 for providing power to the atomizer assembly. The liquid container 13 is arranged at an end of the electronic cigarette body away from the suction end 10, and is detachably connected to the atomizer assembly 12. With such structure, the liquid container can be detached for filling the cigarette liquid, which avoids the situation in the liquid filling process of the conventional electronic cigarette that, the cigarette liquid is overly filled by accident, which causes the smoke channel to be submerged by the cigarette liquid, and further causes the atomizer to be unable to atomize the cigarette liquid.

An accommodating groove is provided in the atomizer assembly 12. A movable member 121 is movably provided in the accommodating groove, and is detachably connected to the liquid container 13. The liquid container 13 may freely rotate with respect to the atomizer assembly 12 together with the movable member 121.

A first engaging portion is provided in the accommodating groove.

A second engaging portion configured to engage with the first engaging portion is provided on a surface of the movable member 121.

In the case that the first engaging portion is engaged with the second engaging portion, the movable member 121 cannot rotate freely with respect to the atomizer assembly 12, and the liquid container 13 may be rotated with respect to the movable member 121, to be detached from the atomizer assembly 12.

In the present application, the liquid container of the electronic cigarette is provided at the end of the electronic cigarette body away from the suction end, that is, the liquid container is arranged away from the suction end, thus, the electronic cigarette according to the present application may effectively prevent a user from inhaling the cigarette liquid which has not been atomized

In the present application, the accommodating groove is provided inside the atomizer assembly, the movable member detachably connected to the liquid container is accommodated in the accommodating groove, and a space is provided between the movable member and the accommodating groove. Thus, the movable member may freely rotate with respect to the accommodating groove, and the liquid container connected to the movable member may freely rotate with respect to the atomizer assembly. The first engaging portion is provided inside the accommodating groove, the second engaging portion configured to engage with the first engaging portion is provided on the surface of the movable member, and in the case that the first engaging portion is engaged with the second engaging portion, a free rotation of the movable member with respect to the atomizer assembly is prevented, thus the liquid container may be rotated with respect to the movable member, to be detached from the atomizer assembly. To engage the first engaging portion with the second engaging portion, an external force is required to be applied on the electronic cigarette, for example pushing the liquid container or pressing the atomizer assembly. Without applying an external force, the first engaging portion cannot be engaged with the second engaging portion, thus the liquid container cannot be detached from the atomizer assembly. Therefore, it is difficult for a child to remove the liquid container. When the child rotates the liquid container, the liquid container can only rotate freely on the atomizer assembly but cannot be removed, thereby avoiding the child sucking in the cigarette liquid in the liquid container by mistake. Further, when the electronic cigarette is used or carried by the user, the liquid container will not be disengaged from the atomizer assembly, thereby avoiding the liquid container being damaged and further affecting the usage of the electronic cigarette.

In the present application, the liquid container 13 is arranged at the end of the electronic cigarette body away from the suction end 10. It can be appreciated that, the suction end 10 is connected to one end of the battery rod assembly 11, the atomizer assembly 12 is connected to another end of the battery rod assembly 11, and the liquid container 13 is connected to the atomizer assembly. Thus, the suction end is arranged at one end of the electronic cigarette body, and the liquid container 13 is arranged at the other end of the electronic cigarette body.

In the present application, a space is provided between the movable member 121 and the accommodating groove inside the atomizer assembly. The atomizer assembly 12 is further provided with an atomizing core 40, and the movable member 121 is of a hollow structure. The atomizing core 40 passes through the hollow structure of the movable member 121. Specifically, the atomizing core 40 passes through the entire atomizer assembly 12, to connect the movable member and the accommodating groove in series.

In the present application, the size of the space between the movable member 121 and the accommodating groove is not limited, and the function of the space is to allow the liquid container 13 and the atomizer assembly 12 to rotate freely with respect to each other. It can be appreciated that, the space is provided between the movable member 121 and the accommodating groove in the radial direction and the axial direction of the electronic cigarette body. When the electronic cigarette body suffers a pressure or a pushing force, for example, the liquid container is pushed towards the atomizer assembly 12, the space between the movable member 121 and the accommodating groove is eliminated. That is, the contact portion between the atomizer assembly 12 and the liquid container 13 is provided with a first engaging portion and a second engaging portion, and at this time, since there is no space between the movable member and the accommodating groove, the first engaging portion can engage with the second engaging portion, which prevents the rotation of the liquid container 13, and then the liquid container 13 can be removed. A direction, in which the force is applied on the electronic cigarette body to engage the first engaging portion with the second engaging portion in this direction to prevent the liquid container 13 from rotating with respect to the atomizer assembly, is not limited herein.

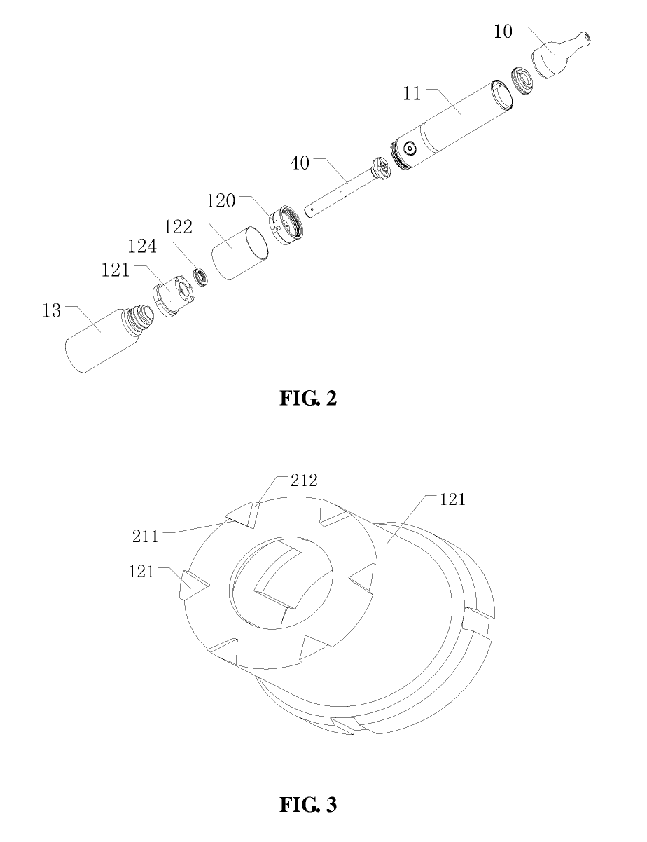

In this embodiment, as shown in FIG. 2, the atomizer assembly 12 is further provided with a connecting member 120 and an atomizing sleeve 122.

The atomizing sleeve 122 is provided for wrapping the atomizer assembly 12 to protect the same.

The accommodating groove is defined by the connecting member 120 and the atomizing sleeve. The atomizing sleeve 122 forms a wall of the accommodating groove, and the connecting member 120 forms an end of the accommodating groove.

It can be appreciated that, the accommodating groove of the atomizing assembly 12 consists of the atomizing sleeve 122 outside the atomizer assembly 12 and the connecting member 120 inside the atomizer assembly 12.

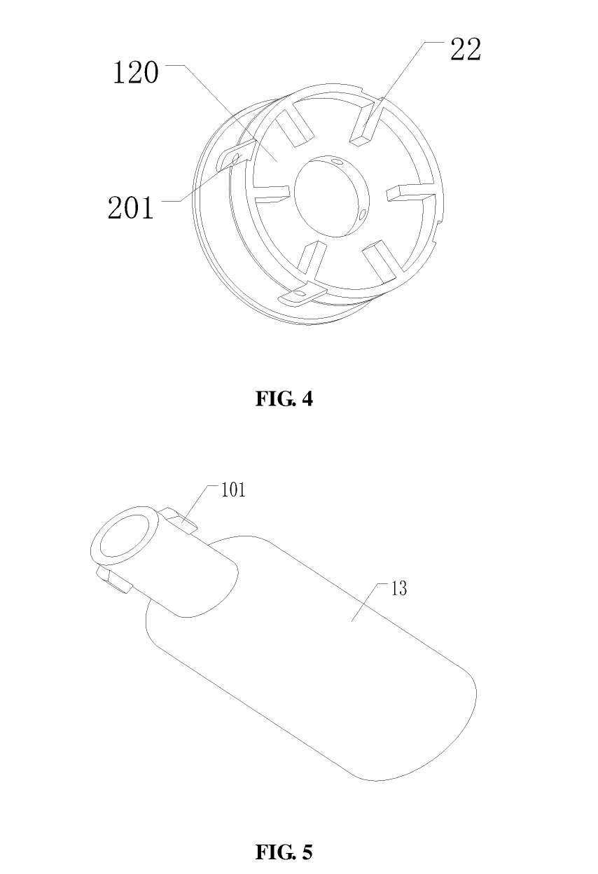

Referring to FIG. 3 and FIG. 4, the first engaging portion is arranged on the surface of the connecting member 120 that may be in contact with the movable member 121, and the first engaging portion is embodied as a first engaging tooth 22.

The second engaging portion is arranged on the surface of the movable member 121 that may be in contact with the connecting member 120, and the second engaging portion is embodied as a second engaging tooth 21.

In the present application, the first engaging tooth 22 is arranged at an end of the connecting member 120, that is, is arranged at the surface of the connecting member 120 that may be in contact with the movable member 121. The second engaging tooth 21 is arranged at an end of the movable member 121, that is, is arranged at the surface of the movable member 121 that may be in contact with the connecting member 120.

In the present application, the detachable connecting manner between the atomizer assembly 12 and the liquid container 13 employs a rotational fastening connection. The rotational fastening connection can be understood as, but not limited to, a threaded connection.

Reference is made to FIG. 7. The second engaging tooth 21 is provided with a first contact surface 211, and the first contact surface 211 is in contact with the first engaging tooth in the case that the second engaging tooth 21 is engaged with the first engaging tooth when the liquid container 13 is rotated in a direction to be fastened to the atomizer assembly 12.

The first contact surface 211 is perpendicular to the surface of the movable member 121.

The second engaging tooth 21 is further provided with a second contact surface 212, and the second contact surface 21 is in contact with the first engaging tooth 22 in the case that the second engaging tooth 21 is engaged with the first engaging tooth 22 when the liquid container 13 is rotated in a direction to be disengaged from the atomizer assembly 12.

The second contact surface 212 is an inclined surface.

It can be appreciated that, when the liquid container 13 is rotated in the direction to be disengaged from the atomizer assembly 12, the inclined second contact surface 212 is in contact with the first engaging tooth 22 when the second engaging tooth is engaged with the first engaging tooth. In a normal state of the electronic cigarette body, a space exits between the liquid container 13 and the atomizer assembly 12, thus, the liquid container 13 and the atomizer assembly 12 may rotate freely with respect to each other. In several cases, for example, an external force, not for removing the liquid container 13, is applied to the electronic cigarette, or the electronic cigarette body is placed upside down, that is, the liquid container 13 is on the top and the suction end is at the bottom, the space between the liquid container 13 and the atomizer assembly 12 is also eliminated, that is, the first engaging tooth 22 can be engaged with the second engaging tooth 21 to remove the liquid container 13. In order to avoid this problem, the second contact surface 212 is embodied as an inclined surface. When the first engaging tooth 22 is engaged with the second engaging tooth 21, the first engaging tooth 22 is engaged with the second contact surface 212 of the second engaging tooth 21, and since the second contact surface 212 is an inclined surface, the first engaging tooth 22 cannot be engaged with the second engaging tooth 21. That is, the first engaging tooth 22 would slide along the inclined surface and therefore cannot engage with the second engaging tooth 21. When the liquid container 13 is rotated reversely, the first engaging tooth 22 is engaged with the second engaging tooth 21, to fasten the liquid container 13 to the atomizer assembly 12.

In this embodiment, if an external force, not for removing the liquid container 13, is applied to the electronic cigarette, or the electronic cigarette body is placed upside down, that is, the liquid container 13 is on the top and the suction end is at the bottom, the space between the liquid container 13 and the atomizer assembly 12 is also eliminated, that is, the first engaging tooth 22 can be engaged with the second engaging tooth 21. In view of this problem, an inclination angle of the inclined surface of the second contact surface 212 is required to satisfy a condition that the first engaging tooth 22 can slide along the inclined surface and cannot be engaged with the second engaging tooth 21. The inclination angle cannot be too large, otherwise, the resistance between the first engaging tooth 22 and the inclined surface would be large, which may cause the first engaging tooth 22 to be engaged with the second engaging tooth 21. In the present application, the inclination angle of the inclined surface is set in a range of 30 degrees to 50 degrees. When the user needs to remove the liquid container 13 from the atomizer assembly, the user can push the liquid container 13 towards the atomizer assembly, and the pushing force is required to be able to prevent the first engaging tooth 22 from sliding along the inclined surface.

In this embodiment, the second engaging tooth 21 may be embodied as an arch body or a polygon which protrudes out of the surface of the movable member, or an arch body or a polygon which is recessed into the surface of the movable member. In this embodiment, the second engaging tooth 21 is preferably embodied as a triangular body. The number of the second engaging tooth 21 may be same as or different from the number of the first engaging tooth 22. If the number of the second engaging tooth 21 is too few, the engagement force between the first engaging tooth 22 and the second engaging tooth 21 would be too small to achieve the effect of the present application. If the number of the second engaging tooth 21 is too large, the manufacturing cost would be increased. In this embodiment, it is preferably to provide six of the second engaging teeth 21.

In this embodiment, the first engaging teeth 22 are arranged on a surface of the connecting member 120 that can be in contact with the movable member 121. The first engaging tooth 22 protrudes out of the surface of the connecting member 120, and is embodied as a polygon. The contact surface of the first engaging tooth 22 and the movable member 121 cannot be too large, otherwise the inclined surface would be functionless, since when the contact surface is too large, the first engaging tooth 22 will not move upward along the inclined surface but will be engaged with the second engaging tooth 21. The first engaging tooth 22 is preferably embodied as a rectangular body, and the contact surface of the first engaging tooth 22 and the movable member 121 is determined according to the diameter of the electronic cigarette body. For example, in the case that the diameter of the electronic cigarette body is 5 mm, the diameter of the contact surface of the first engaging tooth 22 and the movable member 121 may be set in a range of 2 mm to 4 mm. Specifically, the relationship between the diameter of the electronic cigarette body and the dimension of the contact surface of the first engaging tooth 22 and the movable member 121 is not limited. The number of the first engaging teeth 21 may be same as or different from the number of the second engaging teeth 22. In this embodiment, it is preferably to provide six of the first engaging teeth 21.

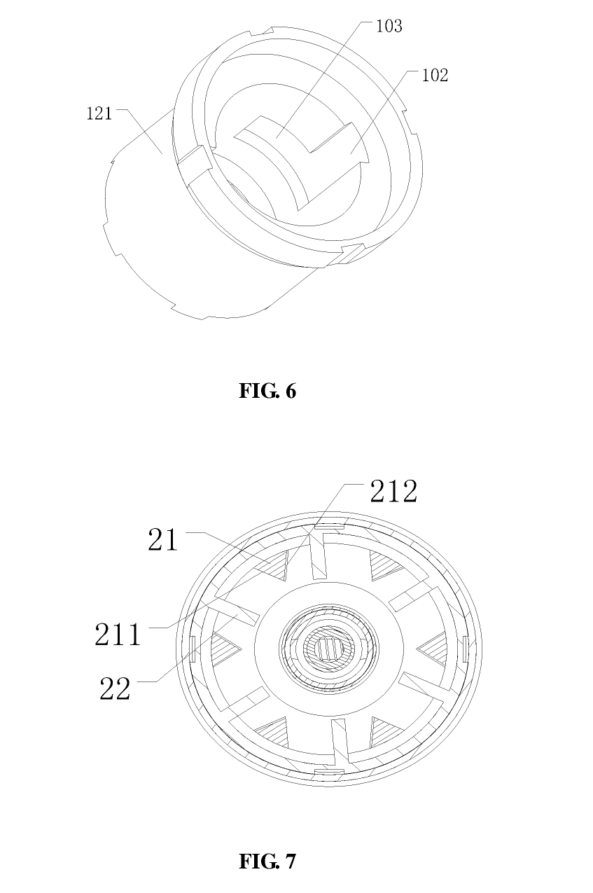

In this embodiment, the rotational fastening connection is a threaded connection. In other solutions, reference is made to FIG. 5 and FIG. 6.

A connecting end, connected to the movable member 121, of the liquid container 13 is provided with a boss 101 protruding out of the surface of the connecting end. A guiding groove 102 for leading in the boss 101 is provided inside the movable member 121. An end of the guiding groove 102 is provided with a limiting groove 103, and the limiting groove 103 is in communication with the guiding groove 102 and extends in the radial direction of the movable member 121. After the boss 101 is inserted into the guiding groove 102 and reaches the end of the guiding groove 102, the boss 101 is rotated into the limiting groove 103, thus the boss 101 is snapped into the limiting groove 103.

In this embodiment, the guiding groove 102 and the limiting groove 103 form an L shape. When the boss 101 is inserted to reach the end of the guiding groove 102, and then is rotated into the limiting groove 103, the boss 101 is snapped into the limiting groove 103. With such manner, the liquid container 13 can be fastened to the movable member 121. In order to realize a better snap fit, an interference fit is provided between the boss 101 and the limiting groove 103.

In this embodiment, a space is provided between the connecting member 120 and the movable member 121. In the space, an elastic element is provided in the atomizing sleeve in the circumferential direction. The elastic element is provided for preventing the engagement between the first engaging portion and the second engaging portion when the liquid container 13 rotates freely with respect to the atomizer assembly 12. The elastic element is provided between the first engaging portion and the second engaging portion to prevent the engagement therebetween, thus when an external force is applied to the electronic cigarette body to engage the first engaging portion with the second engaging portion, the force applied to the movable member 121 is required to be larger than an elastic force of the elastic element, to move the movable member 121 towards the atomizer assembly 12, thus the elastic element is pressed downward to allow the first engaging portion to engage with the second engaging portion. The elastic element may prevent an incorrect engagement between the first engaging portion and the second engaging portion.

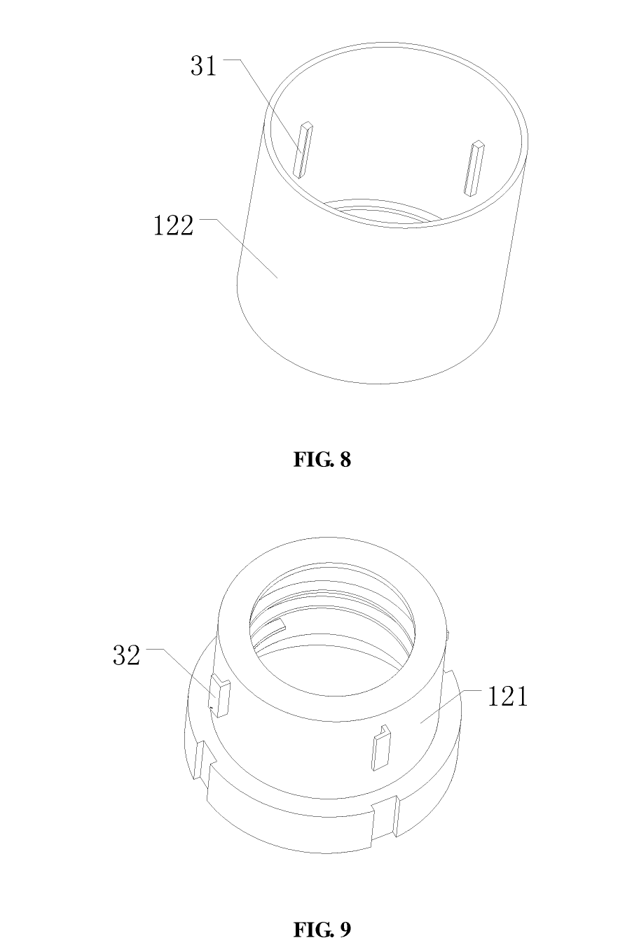

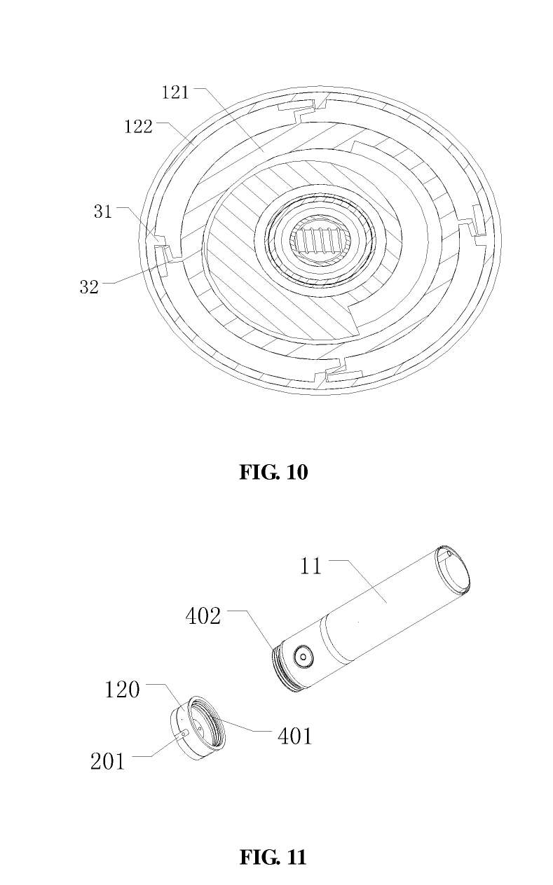

In this embodiment, referring to FIG. 8, FIG. 9 and FIG. 10, the first engaging portion is embodied as a press strip 31 provided on the wall of the accommodating groove.

The second engaging portion is embodied as an elastic fastener 32 provided on the movable member 121 to cooperate with the press strip 31. The elastic fastener 32 is configured to retain the press strip 13 to further prevent a free rotation of the liquid container 13 with respect to the atomizer assembly 12, thus the liquid container 13 can be disengaged from the atomizer assembly 12.

In this embodiment, the elastic fastener 32 may have an L shape, or a U shape, which is not limited herein, as long as it can retain the press strip 31 to further prevent the free rotation of the liquid container 13 with respect to the atomizer assembly 12. When the liquid container is rotated in a direction to be fastened to the atomizer assembly, the elastic fastener 32 presents an elastic force, thus the elastic fastener 32 cannot retain the press strip 31. The press strip 31 may be embodied as an elongated strip arranged in the axial direction of the electronic cigarette body. The length of the elastic fastener 32 may be same as or different from the length of the press strip 31, as long as the retaining force between the elastic fastener 32 and the press strip 31 can prevent the free rotation of the liquid container 13 with respect to the atomizer assembly 12.

In this embodiment, an indicator is arranged outside the atomizer assembly. The indicator is for indicating the position of the elastic fastener, thus the elastic fastener may be pressed by an external force to retain the press strip, to prevent the free rotation of the liquid container with respect to the atomizer assembly. The indicator can function to indicate the pressing position for the user.

In this embodiment, the connecting member 120 is provided with a fixing end, and the fixing end is provided with a retaining groove 201 configured to be fixedly connected to the atomizing sleeve. Referring to FIG. 4, the atomizing sleeve 122 is provided with a retaining portion (not shown), and the retaining portion is configured to cooperate with the retaining groove 201 to fix the connecting member 120. The retaining groove and the retaining portion are provided for fixedly connecting the connecting member 120 to the atomizing sleeve 122.

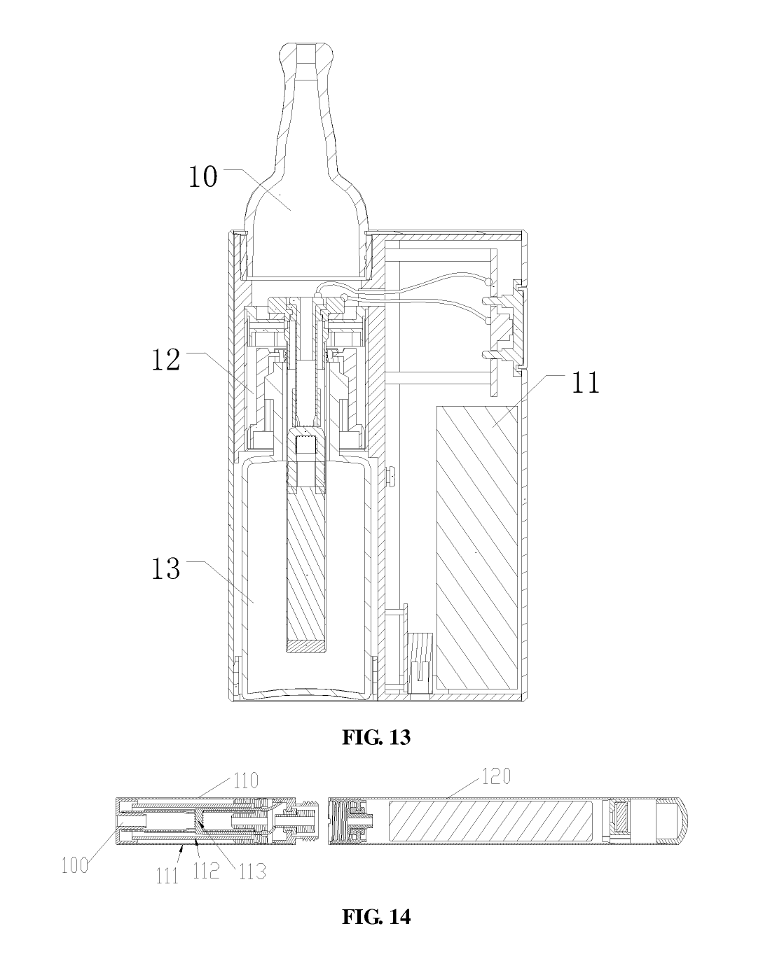

In this embodiment, referring to FIG. 13, the battery rod assembly 11 is arranged in parallel with the liquid container 13. The suction end 10 is connected to one end of the atomizer assembly 12, and the liquid container 13 is connected to another end of the atomizer assembly 12. It can be appreciated that, the battery rod assembly 11 is arranged in parallel with the integrated body including the suction end 10, the atomizer assembly 12, and the liquid container 13. This connecting manner has an advantage of shortening the length of the electrical cigarette body, thus it is convenient for the user to carry the electrical cigarette. The battery rod assembly 11 is arranged in parallel with the liquid container 13, which can prevent the cigarette liquid in the liquid container 13 from flowing into the battery rod assembly 11 to damage the battery.

In this embodiment, referring to FIG. 11, the connecting member 120 is provided with a first connecting portion 401 configured to be threadedly connected to the battery rod assembly 11, and the battery rod assembly 11 is provided with a second connecting portion 402 configured to be cooperatively connected to the first connecting portion 401. The first connecting portion 401 and the second connecting portion 402 are detachably connected. This connecting manner enables the atomizer assembly 12 to be threadedly connected to the battery rod assembly, and the connecting portion of the atomizer assembly is on the connecting member 120.

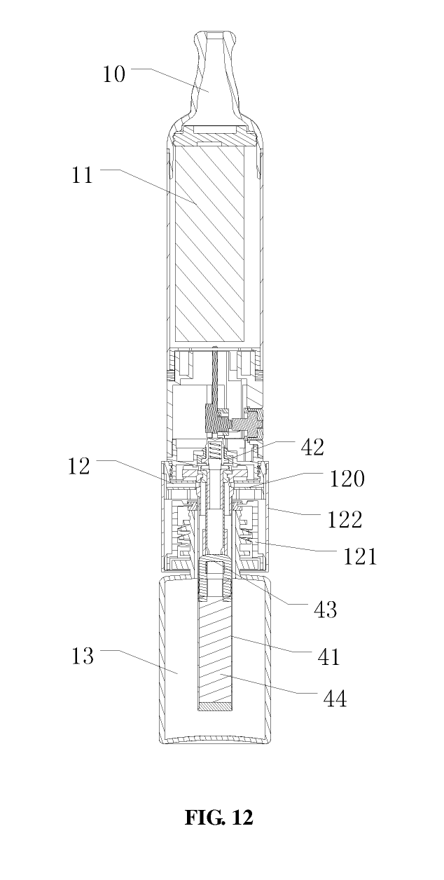

In this embodiment, referring to FIG. 12, the atomizing core 40 includes a sleeve 41, an atomizing electrode 42, an electric heating wire assembly 43, and a cigarette liquid storing member 44.

The cigarette liquid storing member 44 is provided inside the sleeve 41 and fits closely to the inner circumferential surface of the sleeve 41 to prevent the leakage of the cigarette liquid when the liquid container is placed upside down. The sleeve 41 is configured to wrap and protect the cigarette liquid storing member 44. The atomizing electrode 42 is arranged at one end of the sleeve 41, and is configured to communicate the electric heating wire assembly 43 with the battery rod assembly 12, to allow the battery rod assembly 12 to provide power to the electric heating wire assembly 43. The electric heating wire assembly 43 is arranged in the sleeve 41 and is configured to atomize the cigarette liquid to generate smoke. It can be appreciated that, when the atomizer assembly 12 is connected to the liquid container 13, the cigarette liquid storing member 44 is inserted into the liquid container 13, and the cigarette liquid in the liquid container 13 is delivered to the electric heating wire assembly 43 by the cigarette liquid storing member 44, and then is atomized by the electric heating wire assembly 43 by heating, to generate smoke. In addition, the cigarette liquid storing member 44 can further avoid the cigarette liquid in the liquid container being overly delivered to the electric heating wire assembly 43, and avoid dry-heating due to a shortage of the cigarette liquid. The cigarette liquid storing member 44 can deliver the cigarette liquid reasonably and ensures the stability of the smoke. The atomizing core 40 has a compact structure, and the atomized smoke substantially does not pass through the liquid storage area, thereby avoiding the situation in the conventional technology that, when the smoke passes through the liquid storage area, the cigarette liquid may absorb heat from the smoke to condense the smoke, and the user might inhale the condensed cigarette liquid.

In this embodiment, a sealing ring 124 is provided at the contact portion of the movable member 121 and the atomizing core 122. The sealing ring 124 can better seal the cigarette liquid inside the cigarette liquid storing member 44 of the atomizing core 122.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be realized in other embodiments without departing from the spirit or scope of the present application. Therefore, the present application is not limited to the embodiments illustrated herein, but should be defined by the broadest scope consistent with the principle and novel features disclosed herein.

1. An electronic cigarette, comprising an electronic cigarette body, wherein:
the electronic cigarette body is provided with a suction end, a liquid container for containing cigarette liquid, an atomizing assembly for atomizing the cigarette liquid, and a battery rod assembly for providing power to the atomizer assembly; the liquid container is arranged on an end, away from the suction end, of the electronic cigarette body, and is detachably connected to the atomizer assembly;
an accommodating groove is provided in the atomizer assembly, and a movable member is movably provided in the accommodating groove and is configured to be detachably connected to the liquid container, and the liquid container is rotatable freely with respect to the atomizer assembly together with the movable member;
a first engaging portion is provided in the accommodating groove;
a second engaging portion configured to engage with the first engaging portion is provided on a surface of the movable member; and
a free rotation of the movable member with respect to the atomizer assembly is configured to be prevented in the case that the first engaging portion is engaged with the second engaging portion, to allow the liquid container to rotate with respect to the movable member to be disengaged from the atomizer assembly.

2. The electronic cigarette according to claim 1, wherein,
the atomizing assembly is further provided with a connecting member and an atomizing sleeve,
the atomizing sleeve is configured to wrap and protect the atomizer assembly,
the connecting member and the atomizing sleeve define the accommodating groove, and the atomizing sleeve forms a wall of the accommodating groove, and the connecting member forms an end of the accommodating groove,
the first engaging portion is arranged at a surface, configured to be in contact with the movable member, of the connecting member, and the first engaging portion comprises a first engaging tooth, and
the second engaging portion is arranged at the surface, configured to be in contact with the connecting member, of the movable member, and the second engaging portion comprises a second engaging tooth.

3. The electronic cigarette according to claim 2, wherein:
the atomizer assembly and the liquid container are detachably connected by rotational fastening connection,
the second engaging tooth is provided with a first contact surface, and the first contact surface is configured to be in contact with the first engaging tooth in the case that the second engaging tooth is engaged with the first engaging tooth when the liquid container is rotated in a direction to be fastened to the atomizer assembly,
the first contact surface is perpendicular to the surface of the movable member,
the second engaging tooth is further provided with a second contact surface, and the second contact surface is configured to be in contact with the first engaging tooth in the case that the second engaging tooth is engaged with the first engaging tooth when the liquid container is rotated in a direction to be disengaged from the atomizer assembly, and
the second contact surface is an inclined surface.

4. The electronic cigarette according to claim 3, wherein,
the rotational fastening connection is a threaded connection,
or,
a connecting end, connected to the movable member, of the liquid container is provided with a boss protruding out of a surface of the connecting end;
a guiding groove for leading in the boss is provided inside the movable member;
an end of the guiding groove is provided with a limiting groove which is in communication with the guiding groove and extends in a radial direction of the movable member, and
in the case that the boss is inserted into the guiding groove and reaches the end of the guiding groove, the boss is configured to be rotated into the limiting groove, to be snapped into the limiting groove.

5. The electronic cigarette according to claim 3, wherein,
the second engaging tooth is a triangular body protruding out of the surface of the movable member,
or,
the second engaging tooth is a triangular body being recessed into the surface of the movable member.

6. The electronic cigarette according to claim 2, wherein,
a space is provided between the connecting member and the movable member, and in the space, an elastic element is provided in the atomizing sleeve in a circumferential direction, and
the elastic element is configured to prevent engagement between the first engaging portion and the second engaging portion in the case that the liquid container is rotated freely with respect to the atomizer assembly.

7. The electronic cigarette according to claim 2, wherein,
the first engaging portion comprises a press strip provided on the wall of the accommodating groove, and
the second engaging portion comprises an elastic fastener provided on the movable member and configured to cooperate with the press strip, and the elastic fastener is configured to retain the press strip to prevent the free rotation of the liquid container with respect to the atomizer assembly, to allow the liquid container to be disengaged from the atomizer assembly.

8. The electronic cigarette according to claim 7, wherein,
an indicator is provided outside the atomizer assembly, and is configured to indicate the position of the elastic fastener, to allow the elastic fastener to be pressed by an external force to retain the press strip, to prevent the free rotation of the liquid container with respect to the atomizer assembly.

9. The electronic cigarette according to claim 2, wherein,
the connecting member is provided with a fixing end,
the fixing end is provided with a retaining groove configured to be fixedly connected to the atomizing sleeve, and
the atomizing sleeve is provided with a retaining portion configured to cooperate with the retaining groove to fix the connecting member.

10. The electronic cigarette according to claim 1, wherein,
a space is provided between the movable member and the accommodating groove, and is configured to allow the movable member to be rotatable freely with respect to the atomizer assembly.

11. The electronic cigarette according to claim 1, wherein,
the battery rod assembly is arranged in parallel with the liquid container.

12. The electronic cigarette according to claim 1, wherein,
the connecting member is provided with a first connecting portion configured to threadedly cooperate with the battery rod assembly,
the battery rod assembly is provided with a second connecting portion configured to cooperatively connected to the first connecting portion, and
the first connecting portion is detachably connected to the second connecting portion.

13. The electronic cigarette according to claim 1, wherein,
the movable member is of a hollow structure,
the atomizer assembly is further provided with an atomizing core for atomizing the cigarette liquid, and the atomizing core has one end inserted in the liquid container and another end extending out of the liquid container, and
the hollow structure of the movable member is configured to allow the atomizing core to pass through.

14. The electronic cigarette according to claim 13, wherein,
the atomizing core comprises a sleeve, an atomizing electrode, an electric heating wire assembly, and a cigarette liquid storing member,
the cigarette liquid storing member is provided in the sleeve and fits closely to an inner circumferential surface of the sleeve, and is configured to deliver the cigarette liquid in the liquid container to the electric heating wire assembly to be atomized, and to prevent leakage of the cigarette liquid in the case that the liquid container is placed upside down,
the sleeve is configured to wrap and protect the cigarette liquid storing member,
the atomizing electrode is provided at one end of the sleeve, and is configured to communicate the electric heating wire assembly with the battery rod assembly, to allow the battery assembly to provide power to the electric heating wire assembly, and
the electric heating wire assembly is provided in the sleeve and is configured to atomize the cigarette liquid to generate smoke.

15. The electronic cigarette according to claim 13, wherein,
a sealing ring for sealing is provided at a contacting portion of the movable member and the atomizing core.
